(19) United States
(12) Patent Application Publication
(10) Pub. No.: US 2008/0254416 A1
(43) Pub. Date: Oct. 16, 2008

(54) Device For Producing Movement of a Cabin Along 3,4 or 6 Axes

(76) Inventors: Bernard Claudinon, Ramonville Saint-Agne (FR); Jean Broquet, Toulouse (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/814,479

(22) PCT Filed: Jan. 27, 2006
(86) PCT No.: PCT/FR06/00183

§ 371 Date: May 13, 2008

(30) Foreign Application Priority Data
Jan. 28, 2005 (FR) 0500868
Apr. 15, 2005 (FR) 0503750

(51) Int. Cl. G09B 9/08

(52) U.S. Cl. 434/55

(57) ABSTRACT

The invention concerns a device for producing movements of a cabin (or of a platform) along 3, 4 or 6 axes, enabling a dynamic simulator to obtained, easy to produce, light and with little vertical space requirement. It consists of a structure (7) designed to receive a cabin whereof the movement is controlled by a set of six passive or active arms acting in traction/compression connected to the frame (1), the number of active arms being equal to the number of axes of displacements. The drawing represents a version with 4 axes and 4 active arms (12) (13) (14) (64) and 2 passive arms (61) (62). The displacement can be shifted from 4 to 6 axes by activating the arms (61) and (62) and from 4 to 3 axes by rendering passive the arm (64). In certain embodiments, the active arms are mechanized by connecting rods actuated by rotary motors or actuators.

The invention relates to a mechanism for producing movements for a dynamic simulator along 3, 4, or 6 axes, by means of active arms (arms with variable length such as jacks or rods essentially subjected to tension/compression loads) in number (at least) equal to the number of movement axes. More precisely, the invention relates to a device enabling to move a cabin in which takes place at least one passenger, along 6-axes (3 orthogonal rotations and 3 orthogonal translations) by means of 6 arms each activated by one actuator here above named as “active arms”, or in an intermediate version, along 4 predefined axes including two rotations and two translations without parasitic movement detectable by the passenger(s), by means of 4 active arms, or yet in another intermediate version along 3 predefined axes including two rotations and one translation without parasitic motion detectable by the passenger(s), by means of 3 active arms. The device allows combining active arms in number of 3, 4 or 6 with passive arms (fixed length arms) on a fully passive core assembly in order to get a mechanism for producing movement respectively along the above-defined 3 axes, 4 axes, or 6 axes.

Dynamic simulators usually reproduce movements (rotations and translations) along axes in number of 2(2 rotations), 3(2 rotations and one translation), 4(2 rotations and 2 translations) or 6 according to applications, and their mechanization generally makes use of hydraulic, electrical or even pneumatic linear actuators, or of rotary engines associated to crank/rod assemblies. For said <<6 axes>> simulators used in particular in aeronautics and enabling to provide the “passengers” with sensations of acceleration and of rotation and translation motions without parasitic acceleration or motion, these linear actuators are generally implemented in a symmetrical way according to an assembly known as <<Stewart platform>> which, in particular, transmits all efforts towards the frame by means of jacks exclusively subjected to tension and compression loads, thus enabling an easy implementation of the system. However such type of platform is very expensive because of the necessity, inherent to the table kinematics, of making use of jacks with large strokes or strengths as compared to axis-by-axis movement requirement. Moreover, for common use in aeronautics, the maximum size of the platform implemented below the cabin is large, which makes necessary to host the simulators in high ceiling buildings and thus limits yet much more severely the utilizations.

For some applications, the need for motion reproduction is not isotropic and makes possible the use of either a 3 or 4 axes simulator while requiring a good quality in the reproduction of the desired movements without noticeable parasitic movement at the cabin level, or a 6-axis simulator for which three movement axes, below named as “main movements” corresponding to 2 translations and to the rotation about the perpendicular axis (or nearly perpendicular) have amplitudes and required dynamic characteristics larger than the three others below named as “complementary movements”. Notably for aeronautical applications, the most important axes of movement to be reproduced, or those requiring the largest amplitude or dynamics characteristics are, according to specialists, the rotations about horizontal axes and the vertical translation. Rotations must be performed around axes fairly precisely located with respect to the simulator and notably with respect to the passenger(s) seat(s). The goal is then to build devices closely complying with the requirements while minimizing the number of active elements and their sizing constraints and producing the desired movements with the highest achievable fidelity without noticeable parasitic motion for the passengers. It is further attempted to minimize the total height of the whole “dynamic platform and cabin” whilst complying with the required motion ranges, and to build a simple and light mechanism, minimizing manufacturing, assembly, operation, maintenance and transportation costs. It is finally attempted to build a generic modular device allowing a cheap and simple adaptation to the specific needs of different users or to the evolutionary needs of a given user. With respect to this approach, the two major drawbacks of the “Stewart platform” are on the one side the large height requirement, and on the other side the impossibility to benefit from the anisotropy of motion reproduction requirements notably for limiting the number of active elements (linear actuators) in the 3-axis and 4-axis simulator versions.

Many other known implementations of “dynamic tables” with movements around or along less than 6 axes have the drawback of inducing at cabin level, in addition to the desired movements, a strong parasitic translation when producing the nominal rotations. Some other known “dynamic tables” implementations with motion along 6 axes or less than “6 axes” correctly reproduce the movements, but at the expense of heavy or complex mechanical solutions making use for instance of assemblies with linear relative sliding or at the expense of large over sizing of the active arms actuators inherent to the device kinematics architecture choices, or yet at the expense of severe range limitation of the “main translation movement”.

We have noticed that, assuming few approximations of the movements with negligible parasitic motions in dynamic simulator applications, it is possible to restrain the movements of a cabin to two rotations about predefined orthogonal axes (or nearly orthogonal) and one translation along the axis perpendicular (or nearly perpendicular) to the two first ones, by means of three constant length arms subjected exclusively to tension and compression loads (here called <<<passive arms>>), coplanar for the average cabin position, each of these arms being jointed at one end to the frame (fixed) and two of these arms being respectively jointed to two separate points on the mobile, the last arm being jointed to one of the other arms close to its joint with the cabin. It has subsequently been noticed that it is possible to control in a deterministic way the potential remaining motions of the mobile by means of three non coplanar actives arms, each active arms being actuated by the direct or indirect action of a hydraulic, electric or pneumatic jack, or yet by action of a “gear-rotating engine” assembly through a “crank-rod” system. Further reduction of volume requirement or parasitic motions has been achieved through making the additional choice of aligning along a common geometrical axis one of the articulation axes with respect to the frame of each of the 3 passive arms. This additional choice enables for some implementations to combine two of the tree passive arms into one passive subassembly hereafter called <<Rigid V>>, with a single one axis joint on the frame. This <<Rigid V>> however is no longer exclusively subjected to tension/compression loads, but it is still very easy to size and manufacture.

Through analysing the so-defined device for producing movements along three axes, it has been further noticed that it can be extended to devices for producing movement along 4 axes by replacing one (in particular) of the 3 passive arms by one active arm, and because of the initial choice of a “common geometrical axis of articulation with respect to the frame” which remains applicable to the device version for producing movements along 4 axes, at least for the cabin mean position, no significant over-sizing of the actuators of the 3 initial active arms was required further to the addition of a fourth motion axis. Finally, from the so-defined device for producing movements along 4 axes, an extension to a device for producing movements along 6 axes can be easily performed through replacing the last two passive arms by 2 active arms, without requiring any re-sizing of the pre-existing 4 active arms. The amplitude of each degree of freedom along the various axes can be chosen independently from each other.

The present invention relates to a device for producing movements of a cabin along 3 axes including 2 rotations about orthogonal (or nearly orthogonal) axes and a translation along the axis orthogonal (or nearly orthogonal) to the two first ones, said device permitting adaptation, through simple replacement of a passive module by an active module, to allow producing movements of the cabin along 4 axes including 2 rotations about orthogonal axes (or nearly orthogonal) and two orthogonal (or nearly orthogonal) translations, one of which being perpendicular (or nearly perpendicular) to the 2 rotation axes, said device permitting further adaptation through simple replacement of the two other passive modules by two other active modules to allow producing movement of the cabin along 6 axes including 3 rotations about orthogonal axes (or nearly orthogonal) and 3 translations along orthogonal axes (or nearly orthogonal). By extension, the present invention relates to the device for producing movements of a cabin along 3 axes, the device for producing movements of a cabin along 4 axes and the device for producing movements of a cabin along 6 axes as resulting from each of the adaptations or directly derived from these adaptations.

When implemented for producing movement along 3 axes, the device is characterized in that it is made of a structure carrying the mobile cabin, of which the loads due to weight and movements are transmitted to the frame through 3 active arms and 3 passive arms (jacks or rods), the 3 passive arms being characterized in that they are coplanar when the cabin is at its mean position, each of these passive arms being articulated around at least 2-axis on the frame, with one of these axes aligned with the <<Common geometrical axis of articulation with respect to the frame>>, two of these passive arms being moreover articulated one with respect to the other through a one degree of freedom joint and the other passive arm (the single one) being perpendicular to the common geometrical axis of articulation when the cabin is in the mean position, the single passive arm and one of the two other passive arms being further connected to the cabin carrying structure through 3 degree of freedom joints in 2 points roughly located at the same distance from the common geometrical axis of articulation of the arms with respect to the frame. Each of the active arms is connected on the one end to the cabin and on the other end to the frame or to a crank through joints having up to three degrees of freedom so that they only sustain tension/compression loads, said active arms acting globally and deterministically on the 3 axes of motion. Total or partial cabin and passengers weight compensation can be done through an ancillary device, independent from the device subject of the present invention or through the action of elements integrated into the device subject of the present patent application. In both cases, this weight compensation makes use of techniques well within the state of the art.

In another implementation very close to the previous one that allows producing movements along 3 axes, 2 of the passive arms are no more articulated one with respect to the other, but are solidly bonded forming a <<Rigid V>> articulated with respect to the frame around a single axis co-aligned with one of the articulation axes of the other arm with respect to the frame along the <<common geometrical axis of articulation with respect to the frame>>. This implementation is simpler than the previous one, but the adaptation of the device to versions enabling the production of movements along 4 or 6 axes is a bit less straightforward.

In the version that allows producing movement along 4 axes, the device is characterized in that it enables to generate 2 rotations about orthogonal axes (or nearly orthogonal) and 2 translations, one of which being perpendicular or nearly perpendicular to the 2 rotation axes, and in that it is made of a structure that carries the moving cabin, and of which the loads due to weights and movements are transmitted to the frame through 2 passive arms and 4 active arms (jacks or rods) subjected only to tension and compression loads, the two passive arms being coplanar when the cabin is in its mean position and being articulated with respect to the frame each one around two axes one of which being a “common geometrical axis of articulation with respect to the frame” to which they are perpendicular (or nearly perpendicular) when the cabin is in its mean position (no translations nor rotations), the passive arms being furthermore connected to the structure carrying the cabin through 3-degree-of-freedom joints in 2 points approximately located at the same distance from the common geometrical axis of articulation with respect to the frame. The geometrical line connecting the support points of the two passive arms on the cabin carrying structure is of course one of the 2 rotation axes of the dynamic simulator. Three of the four active arms are each connected on the one side to the cabin and on the other side to the frame or to a crank through joints having up to 3 degrees of freedom so that the arms sustain only tension/compression loads. The fourth active arm is coplanar with the 2 passive arms when the cabin is in its mean position. It is connected on the one side to one of the passive arm near its joint with the cabin (or directly to the cabin close to a passive arm joint) and on the other side to the frame or to a crank, through joints each having up to 3 degrees of freedom so that the arms sustain only tension/compression loads. Moreover, this active arm forms together with the passive arm to which it is connected a deformable “V”, the plane of which contains the common geometrical articulation axis of the passive arms with respect to the frame when the cabin is at its mean position and it stays close to this plane for movements within the limits of the authorized amplitudes. This last condition ensures that the action of the relevant active arm on the structure carrying the cabin (or at the tip of the passive arm) results into a force mainly for translation with a small parasitic lever arm with respect to the rotation centre of the moving assembly. The 4 active arms act globally and deterministically on the 4 axes of motion.

In the version that allows producing movements along 6 axes, the device is characterized in that it allows producing 3 rotations about orthogonal axes (or nearly orthogonal) and 3 translations along orthogonal axes or nearly orthogonal, and in that it is made of a cabin carrying structure of which the loads generated by weight and movements are transmitted to the frame only through the 6 active arms (jacks or rods) subjected only to tension/compression loads, the 6 active arms being arranged, when the cabin is in its mean position (no rotations nor translations), similarly to the 4 active arms and the 2 passive arms of the 4-axes table configuration here above.

In the “3-axis” and “4-axis” versions, the invention allows implementing dynamic simulators with respectively only 3 or 4 active elements and featuring a small height requirement as well as characteristics of simplicity (sizing, assembly, operation, maintenance, transportation) which, for given characteristics of the cabin (mass, inertias) and given dynamic requirements (accelerations, speeds, attitudes and ranges) allow minimizing constraints related to the selection and to the characteristics of actuator elements (jacks or gear motors)

In the “6-axis table” configuration with the main translation axis in vertical position, the invention allows implementing a 6-axis dynamic simulator with 6 active elements featuring small height requirement and imposing minimum constraints on the sizing of active elements. Indeed, it offers the possibility to use various types of actuators for various classes of dynamic tables, and to differentiate the actuators on a given table benefiting then from the anisotropy on the characteristics of the desired movement between the 3 “primary axes” and the 3 “complementary axes”. Finally thanks to the good decoupling between the actions of the active arms acting mainly on primary motions and those of the passive arms acting mainly on complementary motions, it avoids any over sizing of the actuators which appear in systems with large cross axis coupling, and moreover it makes possible partial compensation of the effects due to gravity by implementing passive systems associated only with the “vertical” arms.

The invention allows also a progressive upgrade of the dynamic simulator from an initial 3-axis version up to a 4 and then to a 6-axis version, through simple replacement of passive “modules” by active “modules” and this even after the first version operation starts.

According to a preferred implementation of the invention (here after named <<device with direct action jack>>) for a 3-axis version of the dynamic simulator, with 2 rotation axes close to the horizontal plane and a translation close to the vertical axis, passive articulated elements are made of one triangular element and one arm (the useful length of which is significantly larger than the cabin vertical motion range). The passive triangular element and the passive arm have a common “horizontal geometrical axis of articulation with respect to the frame”, the triangular element being articulated with respect to the frame only around this horizontal axis, whereas the passive arm, located close to a perpendicular to the “primary axis of articulation with respect to the frame”, is articulated with respect to the frame around 2-axis including the “geometrical axis of articulation with respect to the frame” and a second orthogonal axis, the arm and the triangular element being moreover located in the same horizontal plane when the cabin is at its mean position and having such lengths that their two connection points to the cabin carrying structure are at the same distance from the “geometrical axis of articulation with respect to the frame”. The 3 active arms are making use of linear actuators in quasi-vertical position, they are connected to the cabin carrying structure through spherical joints or through joints having at least 2 degrees of freedom at one tip and 3 degrees of freedom at the other tip. In that implementation it can be easily noted that when the triangular element and the passive arm rotate by the same angle from the horizontal position, the line joining the points of connection of the arms to the cabin carrying structure (this line is hereafter named: <<cabin longitudinal axis>>) moves as a generator of a cylinder, the axis of which is the <<geometrical axis of articulation with respect to the frame>>. This motion is similar to a vertical translation if the cylinder radius is significantly larger than the requested translation motion amplitude. For example, with a maximum vertical translation motion of +/−0.2 metre and an effective passive arms length of 2 metres, when a vertical translation of 0 to 0.2 metre or of 0 to −0.2 metre amplitude is done, the parasitic translation is limited to 0.01 metre. When the triangular element and the passive arm rotate in opposite directions, the resulting cabin rotation is at first approximation a rotation about a radius of the previous cylinder passing through the “cabin longitudinal axis”, the location of this radius along this axis depending on the relative value of the arm rotations. Finally the last degree of freedom unconstrained by the joints between the cabin on one hand and respectively the triangular element and passive arms on the other hand, about the “Cabin longitudinal axis” allows the second rotational motion. At any time, the translation axis and the two rotation axes are orthogonal. It can be also easily noted that in this implementation, the linear actuators sustain all efforts due to weight and movement creation, whereas the passive arms are subjected to limited loads only during motions or when orientations of the mobile correspond to non-zero rotation angles. Furthermore, this implementation makes cabin access easier, because the upper side and one of the cabin lateral sides are free from any mechanism.

In another preferred implementation (hereafter called <<device with direct action jacks>> for a 4-axis version derived from the 3-axis one with two rotation axes close to the horizontal plane and one translation close to the vertical axis, through the addition of a complementary horizontal translation axis, the 2 passive arms (with useful length greater than twice the cabin vertical motion amplitude) and one of the active arms have a common geometrical horizontal axis of articulation with respect to the frame, the 2 passive arms and this active arm being independently articulated with respect to the base frame about this common axis and about a second axis orthogonal to the common axis and to the arms themselves. By design, when the cabin is in the mean position, the 2 passive arms are perpendicular to the <<common geometrical horizontal axis of articulation with respect to the frame>> and are in the same horizontal plane. The 2 passive arms have same length so that in first approximation, the distance between the two connecting points of the passive arms to the cabin carrying structure and the “common geometrical horizontal axis of articulation with respect to the frame” is and stay nearly equal during the motion within the authorized amplitude range. The shape of the triangular element formed by one of the active arms and one of the two passive arms is modified under the effect of the linear actuator which equips the active arm, resulting in a movement of the point of articulation of the passive arm on the cabin carrying structure, comparable for movements within the limits of the authorized amplitudes, to a translation parallel to the <<common geometrical horizontal axis of articulation with respect to the frame>>. The three other active arms make use of linear actuators in vertical or almost vertical position for the average position of the cabin. They are connected to the cabin carrying structure through joints either spherical or having at least 2 degrees of freedom at one tip and 3 degrees of freedom at the other tip. It can be easily noted in this implementation that when both passive arms rotate by the same angle from the horizontal position around the common axis of articulation with respect to the frame, the line joining the points of connection of arms with the structure carrying mobile (“longitudinal axis of the cabin”) moves along a generator of a cylinder the axis of which is the “common geometrical horizontal axis of articulation with respect to the frame”. This movement is comparable to a vertical translation. When the triangular element formed by the couple “active arm and passive arm” on the one hand and the isolated passive arm on the other hand rotate in opposite directions around the common axis of articulation with respect to the frame, the resultant rotation of the cabin is in a first approximation, a rotation around a radius of the previous cylinder leaning against the “longitudinal axis cabin”. The degree of freedom left free by the passive arms around the “cabin longitudinal axis” allows the second movement of rotation. At any time, the axis of translation and both axes of rotation are orthogonal or almost orthogonal. Finally the movement of each of 2 passive arms in a plane containing the common geometrical axis of articulation with respect to the frame is, for the movements of limited amplitude around the average position, a translation parallel to the common geometrical axis of articulation with respect to the frame. It can be noted that, in this implementation, 3 jacks sustain most of the loads due to weight and movement creation around the 3 primary axes, and that the fourth jack is mostly activated for the production of movement and for supporting the mobile along the second axis of translation. It can be further noted that the 2 passive arms are subjected only to limited loads during motions along the primary axes or when orientations and positions of the mobile correspond to non-zero rotation and translation.

In another preferred implementation of the invention (hereafter named <<device with rotary engines>> which can be applied to devices for producing movements along 3, 4 or 6 axis, the mechanization of the active arms is achieved by means of assemblies of rod-crank type, each crank being articulated around a single axis with respect to the frame so that the angular position of the crank fully defines the rod lower end position, each crank being moreover directly actuated about its axis by means of a rotary gear motor assembly. This implementation allows notably reducing the total height of the simulator for given vertical translation amplitude, through getting rid of the severe constraints in size that result from using direct action jacks mounted in a vertical or even oblique position. It also allows choosing motorization types (rotary engines) potentially cheaper and better adapted for certain applications.

According to another preferred implementation of the invention (hereafter called <<device with indirect action jacks>>), the active arms mechanization is achieved by means of devices of rod-crank type, each crank being articulated about a single axis with respect to the frame, so that the angular position of the crank fully defines the rod lower end position, each crank being moreover actuated by means of electric, hydraulic, or even pneumatic jack acting on a lever interdependent to the crank. This implementation is also compatible with limited simulator height for given amplitude requirement on the movement of vertical translation.

Implementations using rod-crank assemblies can easily be equipped with a weight compensation device, in order to decrease the constant power requested on the motors, said device being implemented by means of levers interdependent to the cranks, said levers being connected at one tip of a spring the other end of which is connected to the frame.

The invention will be better understood with the attached figures noted 1 to 12 that show the various types of implementation:

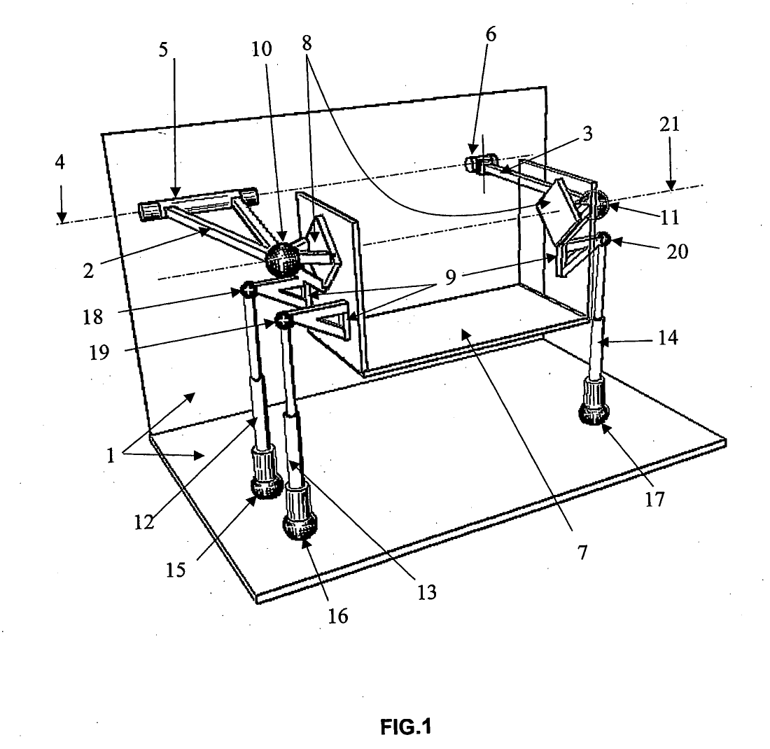

FIG. 1 shows the implementation of said type <<device with direct action jacks>> with a vertical translation axis of the cabin. In this figure, the base frame (1) is made of a horizontal floor and a vertical wall. The passive triangular element (2) and the passive arm (3) are articulated with respect to the frame vertical wall about the <<common geometrical axis of articulation with respect to the frame>> (4). The joint (5) between the triangular element (2) and the frame is of “one-axis” hinge type. The joint (6) between the arm (3) and the frame comprises a “one-axis” hinge for the rotation about the geometrical axis (4) and a “one-axis” hinge for the rotation about the direction perpendicular to the axis (4) and to the arm (3). The arm (3) is perpendicular to the axis (4) when the two arms (2) and (3) are in the same plane (which then contains axis (4)). The cabin carrying structure (7) (which we have made one side transparent to see through and to note the mechanism details behind) is equipped with support points (8) and (9) to which it is firmly connected. Passive arms (2) and (3) are connected to the support points (8) through spherical joints (10) and (11). The geometrical axis going through the centres of joints (10) and (11) was previously called the “Cabin longitudinal axis”. The 3 actives arms (12), (13) and (14) are electrical screw jacks. They are connected to the horizontal frame floor through joints (15), (16) and (17) which are of 2-axis <<Cardan>> type. The active arms are connected to support point (9) through spherical type joints (18), (19) and (20). Each screw jack acts by changing its length in response to an external command. Each length can be continuously changed independently from the two others, so that the cabin carrying structure can be rotated and translated under the jacks action and within the motion range permitted by the triangular element and passive arm reaction. For the purpose of illustration of movements, we explain hereafter the effect of jacks length variations from the mean position of the cabin carrying structure corresponding to the simultaneous horizontal position of the triangular element (2) and of the passive arm (3). From this mean position:
A length increase with identical sign and modulus of the 3 jacks results in a vertical translation of the structure (7).
A length increase of jacks (12) and (13), and a length decrease of jacks (14) result notably in a rotation of the structure (7) about a horizontal direction perpendicular to axis (4).
A length increase of linear actuator (12), and length decrease of linear actuator (13) result notably in a rotation of the structure (7) about the <<cabin longitudinal axis>> (21).

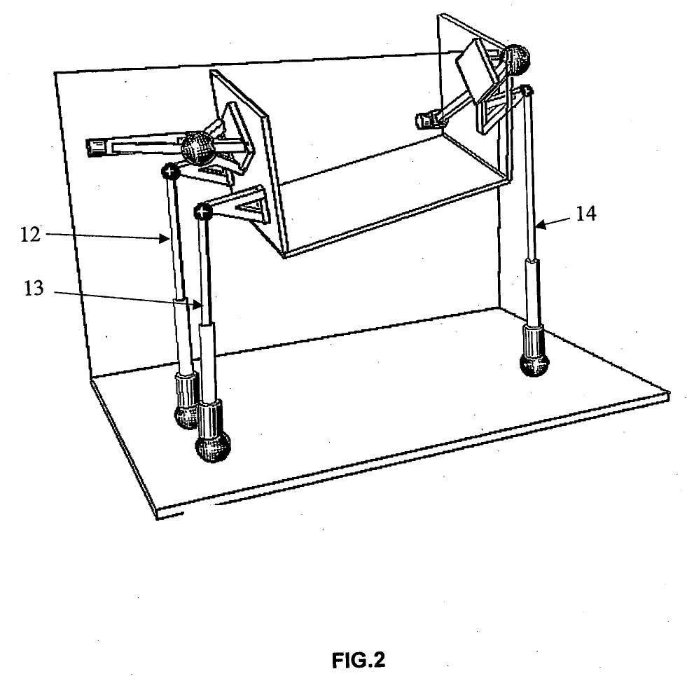

FIG. 2 shows the achievable motions produced by <<device with direct action jacks>>. With such device, any position of the structure (7) compatible with the kinematics imposed by the passive triangular element and the passive arm can be obtained through a unique set of the 3 linear actuators lengths. The figure shows the position and orientation of the cabin resulting from linear actuator (14) length increase larger than the one of linear actuator (12), which is itself larger that the one of linear actuator (13).

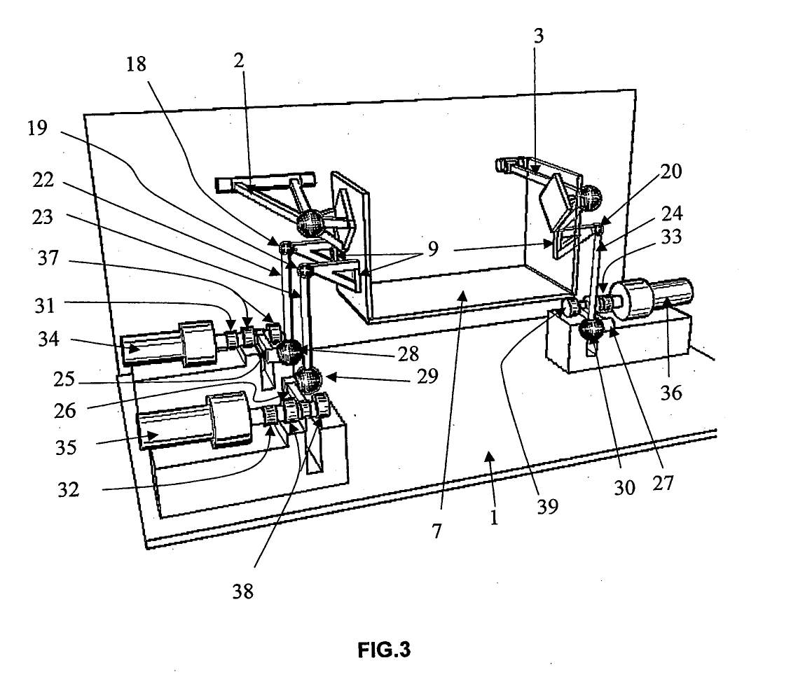

FIG. 3 shows the implementation of the (<device with rotary engines>> with a vertical translation axis of the cabin. In this figure, the frame (1), the cabin carrying structure (7), the passive triangular element (2) and the passive arm (3) are arranged as in FIG. 1. The active arms are made of fixed length rods (22), (23) and (24), jointed to support points (9) interconnected to the cabin carrying structure (7), through spherical joints (18), (19) and (20), and jointed to three cranks (25), (26) and (27) through 2-axis “Cardan” type” joints (28), (29) and (30). Each crank is itself jointed to the horizontal floor of the frame through a one-axis hinge of pivot type. The 3 hinges (37), (38) and (39) have horizontal axes. They are located slightly above the frame floor to make possible a crank rotation from −30° to +30° from the horizontal plane. Cranks are moved into rotations under the action of three rotary engine and gear assemblies (34), (35) and (36) through joints (31), (32) and (33) which ensure the radial loads decoupling between mechanical axes of the engine-gear assemblies and hinges (37), (38) and (39) axes. With this device, any position of the platform (7) compatible with the kinematics imposed by the passive arms can be obtained through a unique set of the 3 angular positions of the cranks.

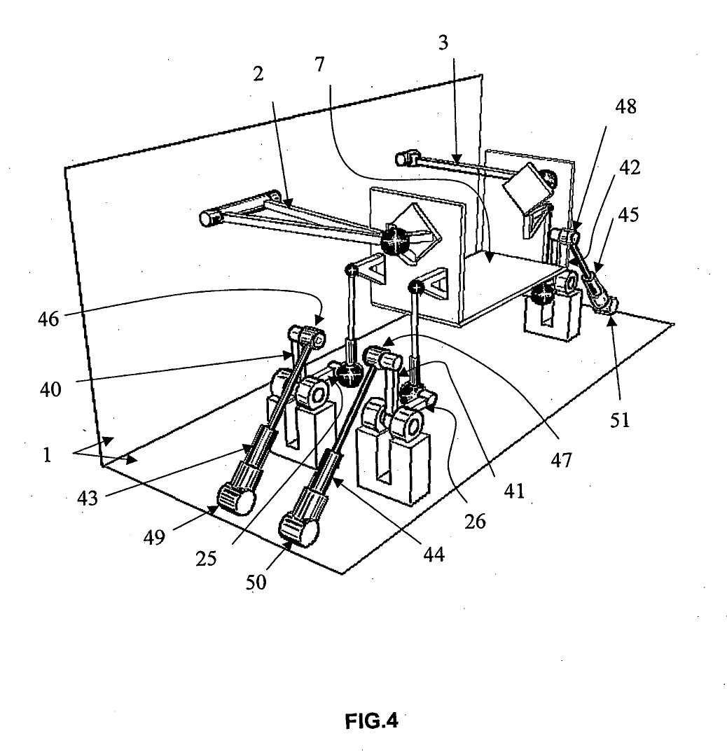

FIG. 4 shows an implementation of the <<device with indirect action jacks>> with a vertical translation axis of the cabin. In this figure, the frame (1), the cabin carrying structure (7), the passive triangle (2) and the passive arm (3) are arranged as in FIG. 1 case. The active arms and the cranks are arranged as in FIG. 3 case. Cranks (25), (26) and (27) are interdependent to the levers (40), (41) and (42) which are themselves actuated by linear actuators (43), (44) and (45). The linear actuators are jointed to the levers through horizontal hinges (46), (47) and (48) of one axis type. The linear actuators are jointed to the frame floor through horizontal hinges (49), (50) and (51) of “one axis” type.

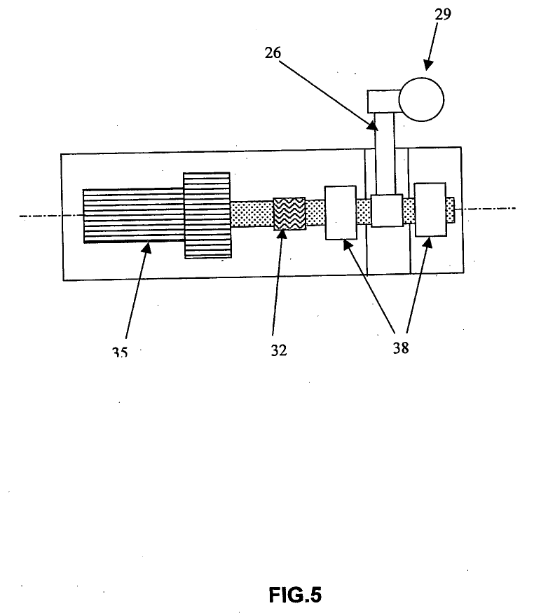

FIG. 5 shows, from above, details of the gear rotary engine assembly (35) and its joint (32), its hinges (38), its crank (26) and its joints to the rod lower end (29) to make clearer the explanation of FIG. 3.

In another implementation of the <<device with rotary engines>> not shown herewith, a static load compensation system is implemented by means of helical springs connected to levers interdependent to the cranks, said levers being arranged such that the springs act either in compression or in tension between the levers and the lower frame, said springs being preloaded to produce an average force on the active arms thus compensating for a portion of the cabin weight.

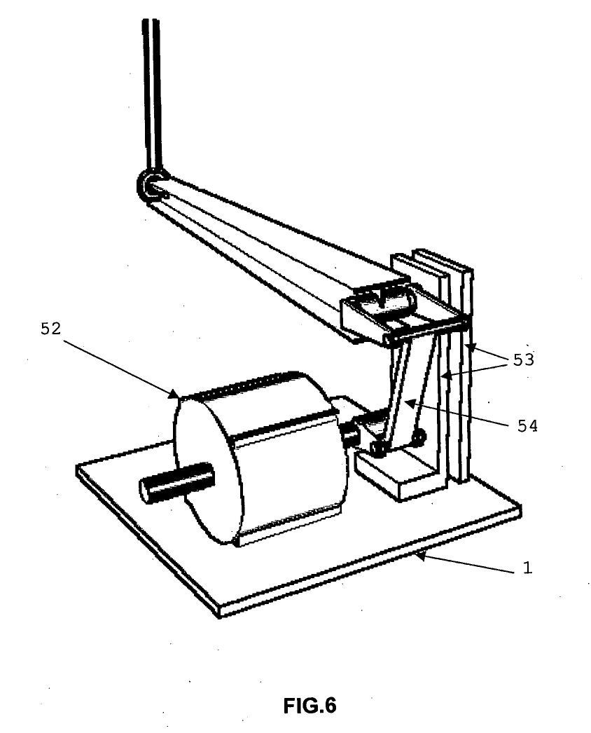

FIG. 6 details a particular implementation of each gear-motor assembly and crank of FIG. 3 where the crank axis is different from the gear axis and where the motion is transmitted through a rod (54). In this implementation, the gear-motor assembly (52) can be placed onto the frame (1), whereas the structure (53), which supports the crank axis, maintains this axis at needed height. Thanks to this transmission system and by a proper choice of the lever arms ratio, the mechanism global safety is improved as the crank angle can be limited whatever the rotation around the gear-motor output axis.

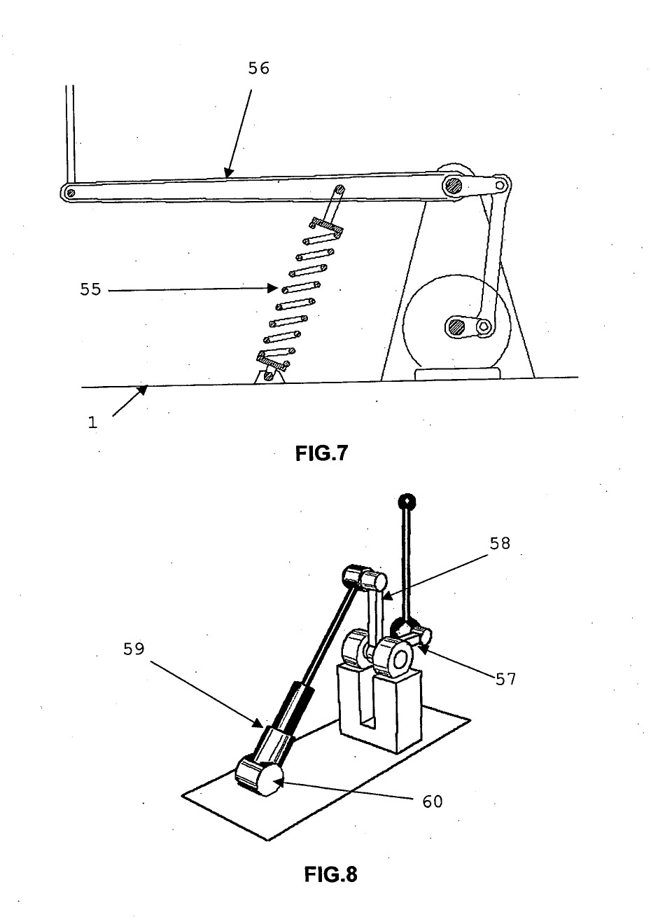

FIG. 7 shows the implementation of a passive and partial compensation system of the loads due to weight. The compression spring (55) acts between the frame (1) and the crank (56) in such a way that the lever arm of the spring action decreases as the spring is compressed, i.e. as its force increases.

FIG. 8 shows a peculiar implementation of a jack-crank assembly usable for a device of “indirect action jacks>> type. The crank (57) is attached to the lever (58), which is itself actuated by the linear actuator (59). The linear actuator is jointed to the frame floor through a horizontal hinge (60) of “one-axis” type.

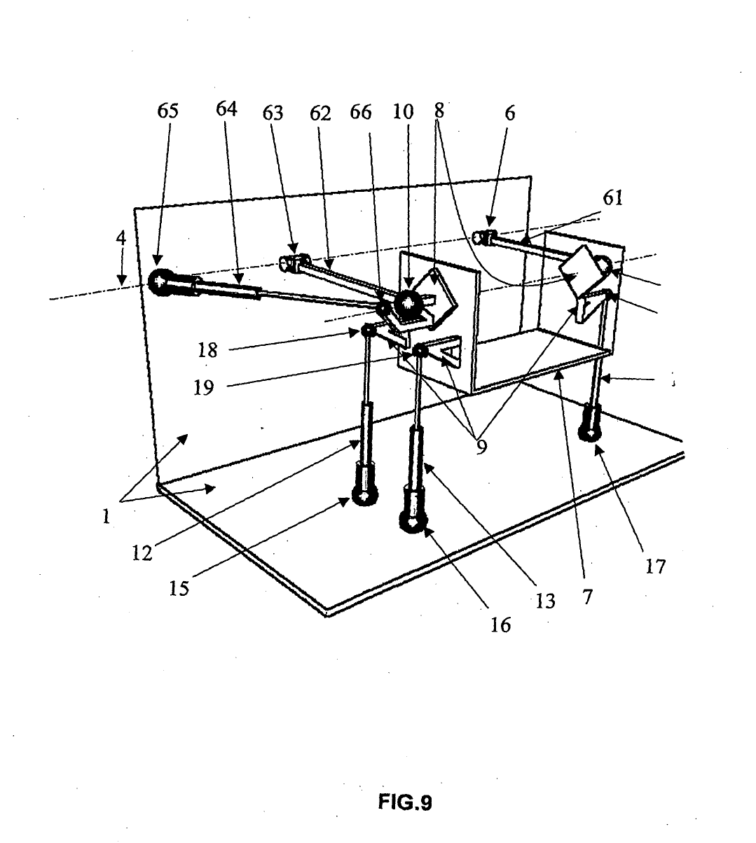

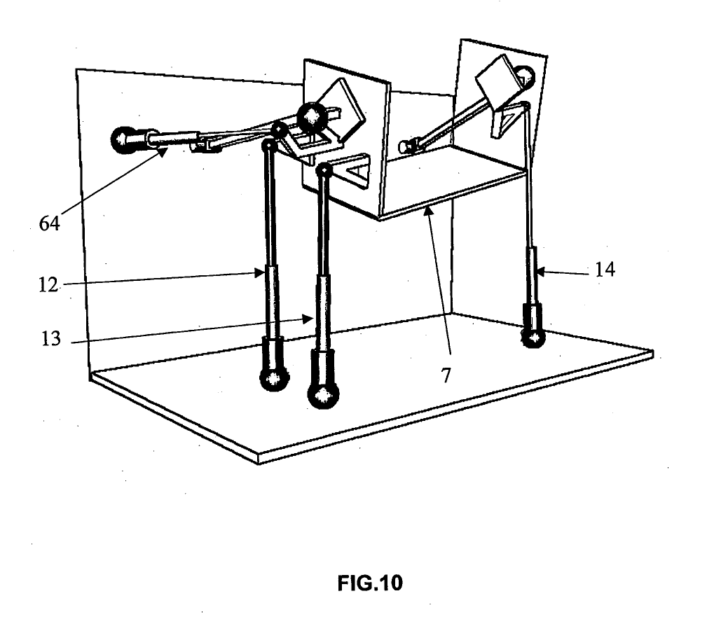

FIG. 9 shows the implementation of a device for producing movements along 4 axes which type is <<device with direct action jacks>> with a vertical cabin primary translation axis. In this figure, the frame (1) is made of a horizontal floor and a vertical wall bearing the joints (63), (6), and (65). Joint (63) of the passive arm (62) on the frame has a “1-axis” hinge for the rotation about the geometrical axis (4) and a “1-axis” hinge for the rotation around the direction perpendicular to axis (4) and to arm (62). Joint (6) of passive arm (61) on the frame side has a “1-axis” hinge for the rotation around geometrical axis (4) and a “1-axis” hinge for the rotation around the direction perpendicular to axis (4) and to arm (61). Arms (61) and (62) are parallel when they are in the same plane, which then also contains axis (4). They are perpendicular to axis (4) when the cabin is in its mean translational position along an axis parallel to axis (4). They have same length. The cabin carrying structure (7) is equipped with interdependent support points (8) and (9). Passive arms (61) and (62) are connected to the support points (8) through joints (10) and (11) of spherical type. The geometrical axis going through centres of joints (10) and (11) was previously named <<cabin longitudinal axis>>. The 4 actives arms (12), (13), (14) and (64) are linear actuators. Arms (12), (13) and (14) are connected to the frame horizontal floor through joints (15), (16) and (17) which are of 2-axis <<Cardan>> type, and to support points (9) through joints (18), (19) and (20) of “spherical type”. Joint (65) of active arm (64) on the frame side is a 2-axis <<Cardan>> type joint in order to ensure rotations about geometrical axis (4) and about the direction perpendicular to axis (4) and to arm (64). The active arm (64) is connected to the support point (8) through the joint (66) of spherical type. Each linear actuator acts by changing its length according to external commands. Each length can be adjusted continuously and independently from the three others, in such a way that the cabin carrying structure can be rotated and translated under jacks actions and passive arms reactions. To illustrate these motions, one could analyse the effect of jack lengths variations starting from the mean cabin carrying structure position which corresponds to having the two arms (61) and (62) horizontal and perpendicular to axis (4)). From this mean position and at first approximation:
A length increase with identical sign and value of the 3 linear actuators (12),(13) and (14) translates into a vertical translation of the structure (7).
A length increase of linear actuators (12) et (13), and a length decrease of linear actuator (14) translate notably into a rotation of structure (7) about an horizontal direction perpendicular to axis (4) and the position of which along axis (4) depends on the relative amplitude length increase/length decrease.
A length increase of linear actuator (12) and a length decrease of linear actuator (13) translate notably into a rotation of structure (7) about the <<cabin longitudinal axis>> (21).
A length increase or decrease of linear actuator (64) only, translates into a translation parallel to axis (4).

FIG. 10 shows the motion capability provided by <<device with direct action jacks>>. With this device, any position of the structure (7) compatible with passive arms kinematics constraints can be obtained by a unique set of the four linear actuators (12), (13), (14) and (64) lengths.

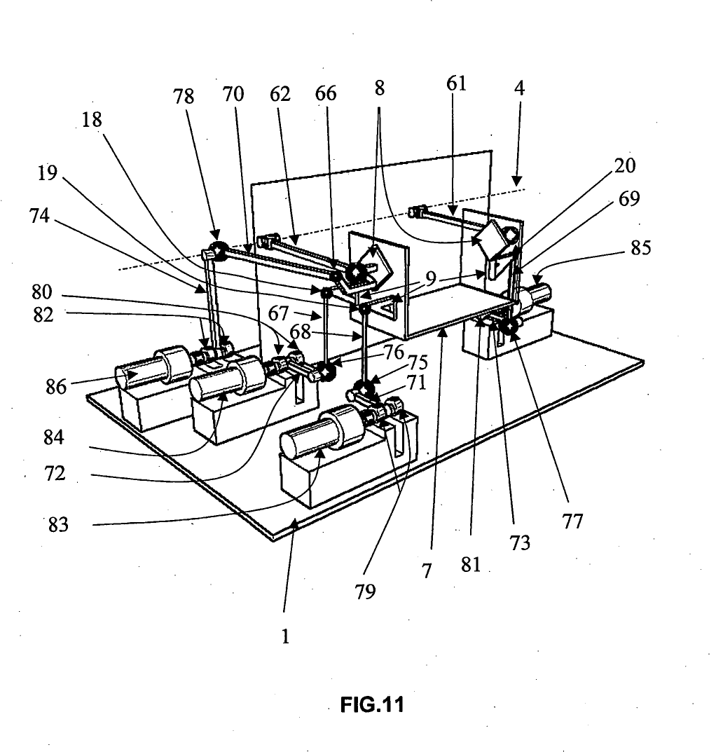

FIG. 11 shows an implementation of device for producing movement along 4 axes which type is <<device with rotary engine>> with a cabin vertical translation axis. In this figure, the frame, the cabin carrying structure and passive arms are arranged as in FIG. 9. Active arms are made for the one part of fixed length rods (67), (68) and (69) jointed to support points (9) interdependent to the cabin carrying structure, through spherical joints (18), (19) and (20), and jointed to three cranks (71), (72) and (73) through 2-axis <<Cardan>> type joints (75), (76) and (77) and for the other part of the fixed length rod (70) jointed to support point (8) interdependent to the cabin carrying structure, through the spherical joint (66), and jointed to the crank (74) through the 2-axis <<Cardan>> type joint (78). Each crank is itself jointed to the frame horizontal floor through a 1-axis hinge of pivot type. The 4 hinges (79), (80), (81) and (82) have horizontal axes. The three hinges (79), (80) and (81) are located at a given height above the frame floor in order to allow cranks rotations from −30° to +30° from the horizontal plane. The cranks are rotated by 4 gear-rotary engine assemblies (83), (84), (85) and (86) through a joint devices that ensure radial efforts decoupling between the mechanical axes of the gear-rotary engine assemblies and of the hinges. With this device, any platform (7) position compatible with the passive arms kinematics can be obtained through a unique set of the 4 cranks position angles.

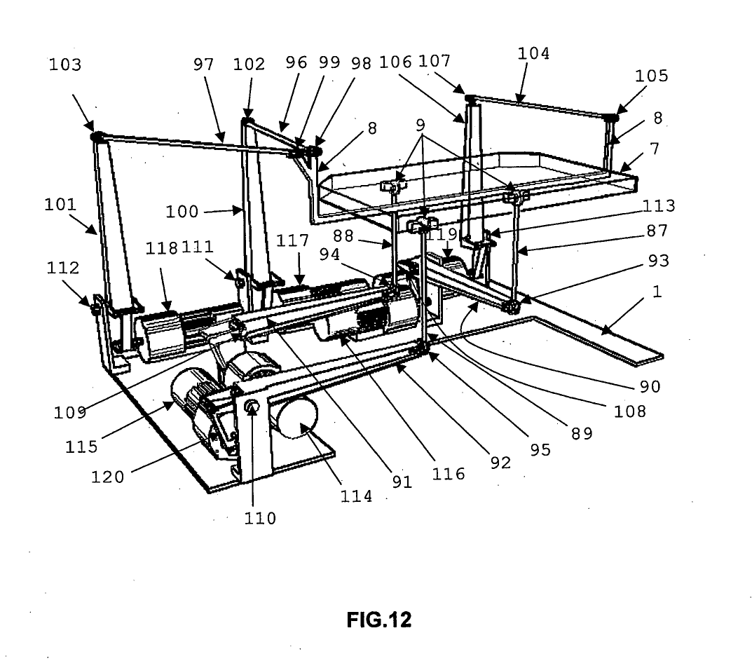

FIG. 12 shows an implementation of a device for producing movements along 6 axes which type is <<device with rotary engines>>. In this figure, the frame (1) is made of a horizontal floor. The cabin carrying structure (7) is equipped with interdependent support points (8) and (9). The device comprises 6 active arms actuated by gear-motors-crank-rod assemblies as also shown in FIG. 6. The active arms are made for one part of fixed length rods (87), (88) and (89) jointed to support points (9) interdependent to the cabin carrying structure, through spherical joints and jointed to three cranks (90), (91) and (92) through 2-axis <<Cardan>> type joints (93), (94) et (95), and for another other part of fixed length rods (96), (97) jointed to support points (8) interdependent to the cabin carrying structure, through spherical joints (98) and (99), and jointed to cranks (100) and (101) through 2-axis <<Cardan>> type joints (102) and (103), and finally of the fixed length rod (104) jointed to the other support point (8) interdependent to the cabin carrying structure, through the spherical joint (105) and jointed to crank (106) through the 2-axis <<Cardan>> type joint (107). Each crank is itself jointed to the frame horizontal floor through a one-axis hinge of pivot type. The six hinges (108), (109), (110), (111), (112) and (113) have horizontal axes. Axes (108), (109) and (110) of the 3 cranks (90), (91), (92) are positioned above the floor to allow cranks rotation angles from −30° to +30° from the horizontal plane. The 6 cranks are moved into rotation by 6 gear-rotary engine assemblies (114), (115), (116), (117), (118) and (119) through a motion coupling device between the gear-motor assembly mechanical axes and the crank axes, such as sub-assembly (120), similar to the one of FIG. 6. With this device, any position of the structure (7) compatible with the mechanism movements ranges can be obtained through a unique set of the six cranks position angles.

1. Device for producing movements of a platform along 3-axes including two rotations axis about orthogonal or nearly orthogonal axes and one translation axis along a direction perpendicular or nearly perpendicular to the two rotations axes, or along 4 axes including two rotations axis about orthogonal or nearly orthogonal axes and two translation axes along orthogonal or nearly orthogonal axes, one of which being in a direction perpendicular or nearly perpendicular to the two rotation axes, or also along 6 axes including three rotations axes about orthogonal or nearly orthogonal axes and three translation axes along orthogonal or nearly orthogonal axes, said device being characterized in that it includes a set of 6 passive or active arms subjected exclusively to tension or compression loads and achieving the kinematics guiding and the actuation to move and position the platform along afore defined 3,4 or 6 axes according to steering commands defined besides at every moment, within the amplitude range for which the device has been designed, said device being further characterized in that the number of active arms is equal to the number of platform movement axes i.e. respectively 3, 4, or 6 active arms for movements along 3,4, or 6 axes, said device being further characterized in that, when the platform is in its mean position corresponding to null displacements, three of the six arms, active or passive according to the number of desired movements axes, are coplanar, the three other arms always active whatever the number of desired movement axes, being non coplanar and perpendicular or nearly perpendicular to the plane which contains the three first ones, said device being further characterized in that the three coplanar or nearly coplanar arms have an articulation about, or close to, a common geometrical axis of articulation with respect to the frame, two of these arms being perpendicular to this common axis of articulation with respect to the frame when the platform is in its mean position, said device being further characterized in that the three coplanar or nearly coplanar arms are connected to the platform one at one point and the two others at another point far from the first one, through joints having three degrees of freedom, the geometrical axis joining these two connection points being parallel or nearly parallel to the common geometrical rotation axis, said device being further characterized in that the two arms connected to the same platform point form a deformable V during the motion, in a mobile plane that contains or stays close to the common geometrical rotation axis.

2. Device for producing movements of a platform along three axes including two rotations axes about orthogonal or nearly orthogonal axes and one translation axis along a direction perpendicular or nearly perpendicular to the two rotation axes, said device being characterized in that it includes three passive arms subjected exclusively to tension or compression loads and limiting at the first order, the possible platform motion to the afore described two rotations and one translation, and three active arms producing or transmitting efforts to move and position the platform around and along these axes according to steering commands defined besides, said device being further characterized in that each of the three passive arms is jointed to the frame about two axes, one of the geometrical articulation axes being common to the three arms, said device being further characterized in that two of the passive arms form a <<V>> having a one degree of freedom hinge at its base, the third passive arm being nominally placed along a direction perpendicular or nearly perpendicular to the common geometrical articulation axis of the passive arms on the frame, the two arms forming the <<V>> on the one hand, and the third passive arm on the other hand being connected to the platform through joints with three degree of freedom in two points nominally located at the same distance from the common geometrical articulation axis of the arms on the frame.

3. Device for producing movements of a platform along 3-axes including two rotation axes around orthogonal or nearly orthogonal axes and one translation axis along a direction perpendicular or nearly perpendicular to the rotation axes, said device being characterized in that it includes a passive arm subjected only to tension and compression loads and a triangular element restraining, at the first order, the possible platform motion to the two rotations and to the translation afore described, and three active arms producing or transmitting the efforts for moving and positioning the platform about and along these axes according to steering commands defined besides, said device being further characterized in that the triangular element is jointed to the frame around a single axis, whilst the passive arm is jointed to the frame around two axes, one of which being aligned with the articulation axis of the triangular element and making therefore a common geometrical axis of articulation with respect to the frame, the passive arm being further characterized in that it is nominally located along a direction perpendicular or nearly perpendicular to the common geometrical articulation axis with respect to the frame, the triangular element and the passive arm also being connected to the platform through three degrees of freedom joints in two points nominally located at the same distance from the common geometrical articulation axis with respect to the frame.

4. Device for producing movements of a platform along 4 axes including two rotation axes about perpendicular or nearly perpendicular axes and two translation axes along orthogonal or nearly orthogonal axes, one of which being along a direction perpendicular or nearly perpendicular to the two rotation axes, said device being characterized in that it includes two passive arms restraining, at first order, the potential platform motion to the said four axes, and four active arms producing or transmitting the efforts for moving and positioning the platform about and along these axes according to steering commands defined besides, said device being further characterized in that each of the two passive arms is separately jointed to the frame about a common geometrical axis and about a second axis allowing to change the angle between the arms and the common geometrical articulation axis, the two passive arms being further oriented along a direction perpendicular or nearly perpendicular to their common geometrical axis of articulation with respect to the frame when the platform is in its mean position which corresponds to null displacements of the platform, and the two passive arms being of equal or nearly equal length and each being connected at one point to the platform through three degree of freedom joints, said device being further characterized in that one of the active arms forms together with one of the passive arms a deformable V during motion, which lies in a plane that contains or stays close to the common geometrical axis of articulation of the passive arms with respect to the frame.

5. Device for producing movements of a platform along 6 axes including three rotation axes about orthogonal or nearly orthogonal axes and three translational axes along orthogonal or nearly orthogonal axes, said device being characterized in that it includes six active arms producing or transmitting the efforts for moving and positioning the platform about and along directions defined at every moment according to steering commands defined besides within the device design range, said device being characterized in that, when the platform is in its mean position corresponding to null displacements, three of the active arms are coplanar or nearly coplanar, the three other arms being non coplanar but perpendicular or nearly perpendicular to the plan that contains the three first ones, said device being further characterized in that, the three coplanar or nearly coplanar active arms have an articulation axis around a common geometrical axis of articulation with respect to the frame or around articulation axes close to it, two of these active arms being perpendicular to this common articulation axis with respect to the frame when the platform is in its mean position, the three active arms being connected to the platform, one of them in one point and the two others in another point far from the first one, through three degrees of freedom joints, the geometrical axis going through these two connection points being parallel or nearly parallel to the common geometrical articulation axis, said device being further characterized in that the two arms attached to the same platform point form during the motion a deformable V, which lies in a plane that contains or stays close to the common geometrical articulation axis.

6. Device as claimed in claim 1, wherein the active arms are made of electric, hydraulic or pneumatic jacks, each of these linear actuators acting directly according to steering values defined besides, in force, speed or position, through length increase/decrease between a connecting point with a 2 or 3 degrees of freedom joint on the frame and another connecting point with a 3 or 2 degrees of freedom joint on the platform, the total number of degrees of freedom for one arm been possibly limited to 5.

7. Device as claimed in claim 1, wherein the active arms are each made of a fixed length connecting rod activated by a crank itself jointed to the frame or an ancillary structure through a one degree of freedom hinge, said device being further characterized in that each rod is jointed to the platform through a 2 or 3 degrees of freedom joint and to the crank through a 3 or 2 degrees of freedom joint, the total number of degrees of freedom for a connecting rod been possibly limited to 5.

8. Device as claimed in claim 7, further characterized in that each crank is connected to a gear-rotary engine assembly which delivers efforts required to rotate it and set its angular position according to external steering commands.

9. Device as claimed in claim 7, further characterized in that each crank is interdependent to a lever, which is actuated by an electric, hydraulic or pneumatic linear jack.

10. Device as claimed in claim 7, further characterized in that each crank or an interdependent lever receive an effort delivered by a passive tension or compression loading system, the purpose of which is to compensate for all or part of static loads generated by the mobile parts under the effect of gravity.

11. Device as claimed in claim 1, further characterized in that the degrees of freedom of the joints are mechanized through ball joints of spherical type, or Cardan type joints, or one axis type hinge.
